(19) United States
(12) Patent Application Publication
(10) Pub. No.: US 2006/0142972 A1
(43) Pub. Date: Jun. 29, 2006

(54) System and method of using sensors to emulate human senses for diagnosing an assembly

(75) Inventors: James J. Cancilla, San Jose, CA (US); Sunil P. Reddy, Corpus Christi, TX (US); Carl J. Krzystofczyk, Mount Prospect, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Snap-on Incorporated, Linconshire, IL (US)

(21) Appl. No.: 11/025,367

(22) Filed: Dec. 29, 2004

(51) Int. Cl. G21C 17/00

(52) U.S. Cl. 702/183

(57) ABSTRACT

A system and method for diagnosing an assembly is provided. The system and method facilitates assembly diagnosis by (i) sensing sensory-inputs coming from the assembly, (ii) capturing data representative of the sensory-inputs and responsively producing sensor patterns indicative of the sensory-inputs, (iii) searching a data base of historical patterns that are related to the sensor patterns, and (iv) presenting the sensor patterns and related historical patterns at a user interface. An assembly diagnosis can be made based on sensor patterns, related historical patterns, and other diagnostic information presented at the user interface.

### FIELD OF THE INVENTION

A method and system for assembly diagnosis, and more particularly to a method and system for assembly diagnosis using sensors that sense a type of input detectable by a human sense.

### BACKGROUND OF THE INVENTION

An assembly consists of two or more components that work cooperatively to enable the assembly to perform a desired function. As an example, an automobile is an assembly of automotive components that work cooperatively to enable the automobile to provide transportation for people using the automobile. As another example, an electric generator is an assembly of generator components that work cooperatively to enable the generator to produce electricity. Other examples of assemblies and/or assembly functions are also possible.

An assembly may malfunction from time to time. An assembly malfunction may include assembly operation that differs from normal assembly operation. An assembly may malfunction for a variety of reasons, such as (i) an assembly component being improperly installed in the assembly, (ii) an assembly component becoming worn, or (iii) an assembly component becoming inoperable. An assembly may malfunction for other reasons as well.

In order for a malfunctioning assembly to operate normally, performance of assembly diagnosis may be necessary to determine why the assembly is malfunctioning. After performance of assembly diagnosis, an assembly repair can be made based on the assembly diagnosis so that the assembly can once again operate normally.

People with varying levels of experience in performing assembly diagnosis may perform assembly diagnosis of a malfunctioning assembly. In some cases, a first person having more assembly diagnosis experience than a second person, may be able to make a correct diagnosis prior to performing any assembly repair work as compared to the second person who may make an incorrect assembly diagnosis and perform unnecessary assembly repair work prior to making the correct assembly diagnosis and repair work. In this regard, the second person may take longer to repair the assembly and cost more than the first person diagnosing and repairing the assembly.

A person performing assembly diagnosis may rely on his or her senses to detect one or more assembly operating conditions. Various types of assembly operating conditions may be detected. For example, an operating condition may be a known malfunctioning condition of an assembly. In this regard, the person diagnosing the assembly could use the known malfunctioning condition to determine why the assembly is malfunctioning. For instance, a person may (i) visually inspect the assembly to look for worn, inoperable, or missing assembly components causing an assembly to malfunction, (ii) listen to the assembly during assembly operation for indication that the assembly is malfunctioning, (iii) touch the assembly or assembly components to sense an assembly condition that indicates the assembly is malfunctioning, and/or (iv) smell an assembly condition that indicates that the assembly is malfunctioning.

Another type of operating condition is a known good operating condition. Known good operating conditions may be used for comparing to a known malfunctioning operating condition and for other reasons as well. Known good operating conditions may be used in diagnosing an assembly to verify that a given assembly component is not malfunctioning and thus avoid unnecessary replacement of a the given assembly component.

A person performing assembly diagnosis may be able to compare assembly operating conditions for a malfunctioning assembly to secondary assembly operating conditions. The secondary assembly operating conditions may be used to indicate whether the assembly operating conditions are normal (a known good operating condition) or indicative of a malfunction (a known malfunctioning operating condition).

Secondary assembly operating conditions may be obtained in a variety of ways. For example, secondary assembly operating conditions may be obtained by operating a second assembly that is substantially similar to the malfunctioning assembly. As another example, the secondary assembly operating conditions could be assembly conditions recalled from the memory of the person performing the assembly diagnosis. Such memories could include a recollection of a perceived malfunction condition and/or a recollection of how an assembly or its components normally operate. In this regard, the secondary assembly operating conditions are historical operating conditions that can only be recalled by the person remembering the operating conditions.

In some cases, secondary assembly operating conditions may not be available to the person performing the assembly diagnosis. In addition, relying on a person's memory of secondary assembly operating conditions is inherently unreliable and inaccurate, as memories are subject to fading and imprecision. Thus, it would be useful and advantageous to have a system and method for diagnosing an assembly that can emulate the senses of a person skilled in performing assembly diagnosis and to have secondary assembly operating conditions available to a person performing assembly diagnosis for comparison to assembly operating conditions of a malfunctioning assembly.

### SUMMARY

A system and method are provided for diagnosing various types of assemblies, such as an automobile or an electric generator. The system and method may facilitate diagnosis of an assembly by (i) sensing sensory-inputs coming from the assembly, (ii) capturing data representative of the sensory-inputs and responsively producing sensor patterns indicative of the sensory-inputs, (iii) searching a data base of historical patterns (e.g. patterns of known-good sensory-inputs from the assembly and/or patterns of known malfunctioning operating condition sensory inputs from the assembly) that are related to the sensor patterns, and (iv) presenting the sensor patterns and related historical patterns at a user interface. In this regard, a person diagnosing the assembly can compare a sensor pattern of a sensory input to a related historical pattern of a sensory input and make a more informed diagnosis of the assembly.

Various types of sensors may be used to sense the sensory inputs from the assembly. A human can sense (via a human sense) at least a portion of each type of sensory input. However, the sensors used by the system for assembly diagnosis may have increased sensing capabilities as compared to the human senses. For example, a sensor may be able to sense a sensory input in a range beyond what a human can sense, such as detecting a ultrasonic sound wave, which cannot be heard by humans. As another example, a sensor may be able to detect a variation in a sensory input at a level that is not detectable by a human sense, such as a small variation in temperature or an actual temperature value.

With respect to a system for assembly diagnosis, the system could include (i) a first sensor for sensing a first type of sensory input and for responsively producing a first sensor output, (ii) a second sensor for sensing a second type of sensory input and for responsively producing a second sensor output, (iii) data storage for storing historical patterns of the first and second types of sensory input, (iv) a processor, and (v) a user interface. The processor receives the first sensor output and responsively sends the first sensor output to the data storage for storage as a first sensor pattern, and receives the second sensor output and responsively sends the second sensor output to the data storage for storage as a second sensor pattern. Thereafter, the processor can search the data storage to locate first and second historical patterns that are related to the first and second sensor patterns, respectively. In this regard, the first historical pattern is a historical pattern of the first type of sensory input and the second historical pattern is a historical pattern of the second type of sensory input. The user interface can be used to display the first and second sensor patterns and the first and second historical patterns in order to facilitate assembly diagnosis.

With respect to a method for assembly diagnosis, the method could involve sensing two or more sensory inputs produced by the assembly and responsively producing a sensor pattern for each type of sensory input sensed. A first type of sensory input could be a sensory input that can be sensed by a first human-sense, such as the sense of hearing. A second type of sensory input could be a sensory input that can be sensed by a second human-sense, such as the sense of touch. After producing the sensor pattern for each sensory input, a processor searches for historical patterns of each type of sensory input stored in data storage in order to locate at least one historical pattern related to the sensor pattern of each type of sensory input sensed. After locating a respective historical pattern related to each type of sensory input sensed, each historical pattern and related sensor pattern can be provided at a user interface to facilitate assembly diagnosis by the user.

These as well as other aspects and advantages will become apparent to those of ordinary skill in the art by reading the following detailed description, with reference where appropriate to the accompanying drawings.

### BRIEF DESCRIPTION OF DRAWINGS

Various examples of embodiments of a method and system for diagnosing an assembly are described herein with reference to the following drawings, in which:

FIG. 1 depicts a simplified block diagram of an example of a system with one sensor for diagnosing an assembly;

FIG. 2 depicts a simplified block diagram of an example of a system with a plurality of sensors for diagnosing an assembly; and

FIG. 3 is a flow chart depicting functions that may be carried out in accordance with an embodiment of a system for diagnosing an assembly.

### DETAILED DESCRIPTION

1. Example of a System with One Sensor for Assembly Diagnosis

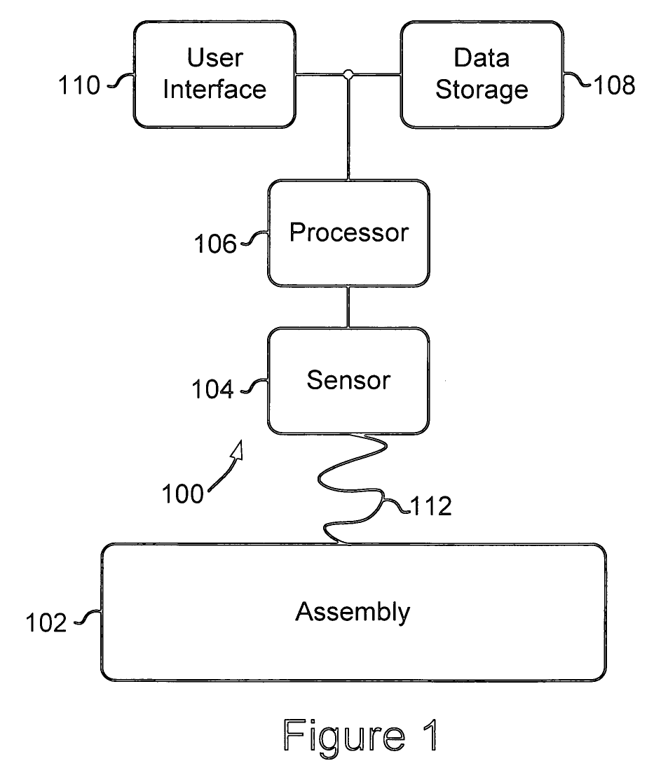

FIG. 1 is a simplified block diagram of an example of a system for diagnosing an assembly. It should be understood that this and other arrangements described herein are set forth only as examples. Those skilled in the art will appreciate that other arrangements and elements (e.g., machines, interfaces, functions, orders, and groupings of functions, etc.) can be used instead, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. Various functions may be carried out by a processor executing instructions stored in data storage.

As shown in FIG. 1, a system 100 for diagnosing an assembly 102 includes a sensor 104, a processor 106, data storage 108, and a user interface 110. The assembly 102 may include a combination of mechanical and electrical components (and other components) that work cooperatively to perform a desired function. Throughout this detailed description and by way of example, the assembly 102 is an automobile. However, other examples of the assembly 102 are also possible. For example, the assembly 102 could be (i) an electric generator, (ii) a pump, such as a water pump or a vacuum pump, (iii) an air plane, (iv) a locomotive, or (v) a motor vehicle such as a van, truck, motor home, semi-tractor trailer, motor cycle, or boat. Other examples of the assembly 102 are also possible.

For purposes of this application, a sensory input is a stimulus detectable by a human sense and/or a sensor. The assembly 102 may produce one or more types of sensory inputs. For example, the assembly 102 may produce a sensory input in the form of a sound wave that can be sensed by the human sense of hearing and/or a sensor such as a microphone. As another example, the assembly 102 may produce a sensory input in the form of a vibration that can be sensed by the human sense of touch and/or a sensor such as an electronic vibration analyzer. As yet another example, the assembly 102 may produce a sensory input in the form of a light wave reflecting from an assembly component that can be sensed by the human sense of sight and/or a sensor such as an image-capturing mechanism. As still yet another example, the assembly may produce a sensory input in the form of a gas having a particular composition that may be sensed by the human sense of smell and/or a sensor such as an exhaust gas analyzer. Other examples of sensory inputs produced by the assembly 102 that are detectable by a human sense and/or a sensor are also possible.

The sensor 104 senses a sensory input 112 produced by the assembly 102 and responsively produces a sensor output indicative of the sensory input 112. The sensor output is sent to the processor 106. The sensor output may be in the form of an analog sensor output or a digital sensor output. An analog sensor output may pass through an analog-to-digital converter (not shown) on its way to the processor 106. Alternatively, the processor 106 itself may include an analog-to-digital converter to convert the analog sensor output to a digital sensor output.

The sensor 104 may sense an entire range of a sensory input that can be sensed by a human sense. The sensor 104 may also have increased sensing capabilities as compared to a human sense. In one regard, the sensor 104, as compared to a human sense, may have a greater sensory range for a particular type of sensory input. For example, a human may be able to sense sound waves only between 20 hertz and 20 kilo-hertz, whereas a sensor in the form of one or more sound wave transducers may be able to sense sound waves between 20 hertz and 40 kilo-hertz. In another regard, the sensor 104, as compared to a human sense, may be able to discern a smaller incremental change in a particular type of sensory input. For example, a human hand may only be able to discern a temperature differential of 2° C., whereas a sensor may be able to discern a temperature differential of 0.125° C. In yet another regard, the sensor 104 can produce a signal that indicates a precise value of a sensor input, whereas a human being using only his or her senses may only guess the value of the sensor input. As an example, the sensor 104 can produce a signal that indicates a precise temperature value, whereas a human being using only his or her senses may only guess the temperature value.

The processor 106 could comprise one or more processors, such as a general purpose processor and/or a digital signal processor. The processor 106 executes machine language instructions that are stored in data storage 108. As an example, the processor 106 may execute machine language instructions to convert an analog sensor output to a digital sensor output and then responsively send the digital sensor output to the data storage 108.

As another example, the processor 106 may execute machine language instructions to produce a sensor pattern based on the sensor output produced by the sensor 104. A sensor pattern represents the sensor output over a given period of time. The accuracy of the sensor pattern depends in part on the number of samples taken of the sensor output over the given period of time. The processor 106 may also execute machine language instructions to convert a sensor pattern (or sensor output) in a first spectrum (such as a spectrum with respect to time) to a sensor pattern (or sensor output) in a second spectrum (such as a spectrum with respect to frequency). Other examples of machine language instructions executable by the processor 106 are also possible.

The data storage 108 may be arranged in various ways. For instance, the data storage 108 may include a computer readable medium, such as a magnetic disc, an optical disc, organic memory, and/or any other volatile or non-volatile mass storage system readable by the processor 106. In this regard, the data storage 108 may be (i) co-located with the sensor 104 and/or the processor 106, or (ii) located remote from the sensor 104 and/or the processor 106. An example of a remote location is a diagnostic center operated by (i) a manufacturer of the system 100, or (ii) a party contracted by the manufacturer of the system 100. In another instance, the data storage 108 may include a combination of one or more segments of computer readable media. In this regard, the one or more segments of data storage may be co-located or at two or more locations. As an example, the data storage 108 may include a first segment of data storage located within the processor 106 and a second segment of data storage located remote from the processor 106.

The second segment of data storage could be located at various locations. For instance, the second segment of data storage may be co-located with the sensor 104 within a moveable cart. In this regard, the moveable cart may be located in close proximity to the assembly 102 such that the sensor 104 can detect a sensor input from the assembly. In another instance, the second segment of data storage may be at a location remote from the sensor 104 and the assembly 102. In this regard, the second segment of data storage may reside at a facility for diagnosing a plurality of assemblies, such as at a diagnostic center (described above). Other examples of the data storage 108 are also possible.

The one or more segments of data storage may be communicatively coupled together via a wireless and/or wired communication mechanism. As an example, a wireless mechanism may include a cellular air interface operating according to the CDMA (code division multiple access) protocol. As another example, a wired mechanism may include a wired packet-switched network in the Internet. Other examples of wireless communication mechanisms and wireless communication mechanisms are also possible.

The data storage 108 may store a variety of data. For example, the data storage 108 may store the machine language instructions executable by the processor 106 and the sensor patterns produced by the processor 106. The data storage 108 may also store diagnostic information based on a sensor output received by the processor 106.

In order to find data in the data storage 108, the processor 106 executes machine language instructions for searching the data storage 108. A data storage search may be based on a variety of search criteria, such as a sensor pattern produced by the processor 106. After locating the data being searched for based on the search criteria, the processor 106 may send the data, such as diagnostic information, to the user interface 110.

One form of diagnostic information is a historical pattern. A historical pattern is a pattern of a sensory input that is captured for use in diagnosing the assembly 102. A historical pattern could be based on a sensory input produced by the assembly 102 or by another assembly, such as a test assembly that is substantially identical to the assembly 102. A historical pattern may represent a sensory input produced by the test assembly when the test assembly is functioning normally or when the test assembly is malfunctioning. Historical patterns may be used for comparison with a sensor pattern to facilitate diagnosing whether the assembly 102 is functioning normally or whether the assembly 102 is malfunctioning.

Comparison of historical patterns to sensor patterns may occur in various ways. For example, the system 100 may provide a historical pattern(s) and a sensor pattern(s) at the user interface 110 (as described below). In this regard, a user of the system 100 may make a comparison of a historical pattern(s) to a sensor pattern(s).

As another example, the processor 106 may make a pattern comparison. In this regard, the processor 106 may determine a mathematical representation of a sensor pattern and compare it to a mathematical representation of a historical pattern (which may be stored in data storage 108 in the form of the mathematical representation).

Representing patterns mathematically may occur in various ways. For example, a mathematical representation of a pattern (historical and/or sensor) may include data that indicates a slope of the pattern at any given point(s) of the pattern. As another example, a mathematical representation of a pattern may include a frequency spectrum representation of the pattern for comparing patterns based on the frequency components of patterns.

As yet another example, the processor 106 may make a pattern comparison in part by determining a correlation between a historical pattern and a sensor pattern. In this regard, the processor 106 could be arranged as described in U.S. Pat. No. 6,687,416 by Wang, which is entitled Method for determining a correlation between images using multi-element image descriptors. U.S. Pat. No. 6,687,416 is hereby incorporated by reference. Other examples of comparing historical and sensor patterns are also available.

Another form of diagnostic information is information related to the sensor output (or sensor pattern). For example, the diagnostic information may include diagnostic instructions for guiding a user of the system 100 in diagnosing the assembly 102 based on the sensor output received by the processor 106. As another example, the diagnostic information may include assembly repair instructions for guiding a user of the system 100 in repairing the assembly.

The user interface 110 provides a user of the system 100 with an interface to communicate with the system 100. The user interface provides means for a user to enter data into the system 100, as well as means for a user to receive data from the system 100.

The user interface 110 may be arranged in various ways so that a user can enter data into the system. For example, the user interface 110 could include a keyboard or an LCD touch monitor for entering data into the system 100. As another example, the user interface 110 could include a speech recognition system for recognizing voice commands spoken by the user. Other examples of means for a user to enter data into the system 100 are also possible.

The user interface 110 may be arranged in various ways so that a user can receive data from the system 100. The user interface 110 may be arranged to provide an image to a user. For example, the user interface 110 may provide an image of (i) a sensor pattern produced by the processor 106, (ii) an image of a historical pattern stored in the data storage 108, or (iii) diagnostic information, such as assembly diagnostic guidelines and/or assembly repair guidelines. The user interface 110 may display only a single image at any one time. Alternatively, the user interface 110 may simultaneously display one or more images, such as a sensor pattern, a historical pattern, and assembly diagnostic guidelines. Examples of devices for displaying an image at the user interface include a cathode ray tube (CRT) or a liquid crystal display (LCD). Other examples of devices for displaying an image are also possible.

The user interface 110 may also be arranged to provide various sounds to the user of the system 100. In this regard, the user interface 110 may play sounds represented by a historical pattern for comparison to the sound waves produced by the assembly 102. Also, in this regard, the user interface 110 may play audio recordings of the assembly diagnostic guidelines and/or the assembly repair guidelines. As an example, the user interface 110 may include a sound card and a speaker for playing sounds and audio recordings. Other examples are also possible.

The user interface 110 may be located at various locations. For example, the user interface 110 may be located in a service garage along with the sensor 104 and the assembly 102. In this regard, a person at the service garage may use the user interface 110 to diagnose the assembly 102. As another example, the user interface 110 may be located at a first location, such as a diagnostic center, whereas the sensor 104 and the assembly 102 may be located at a second location, such as a service garage. In this regard, a person at the first location may use the user interface 110 to diagnose the assembly 102 located at the second location.

2. Example of a System with a Plurality of Sensors for Assembly Diagnosis

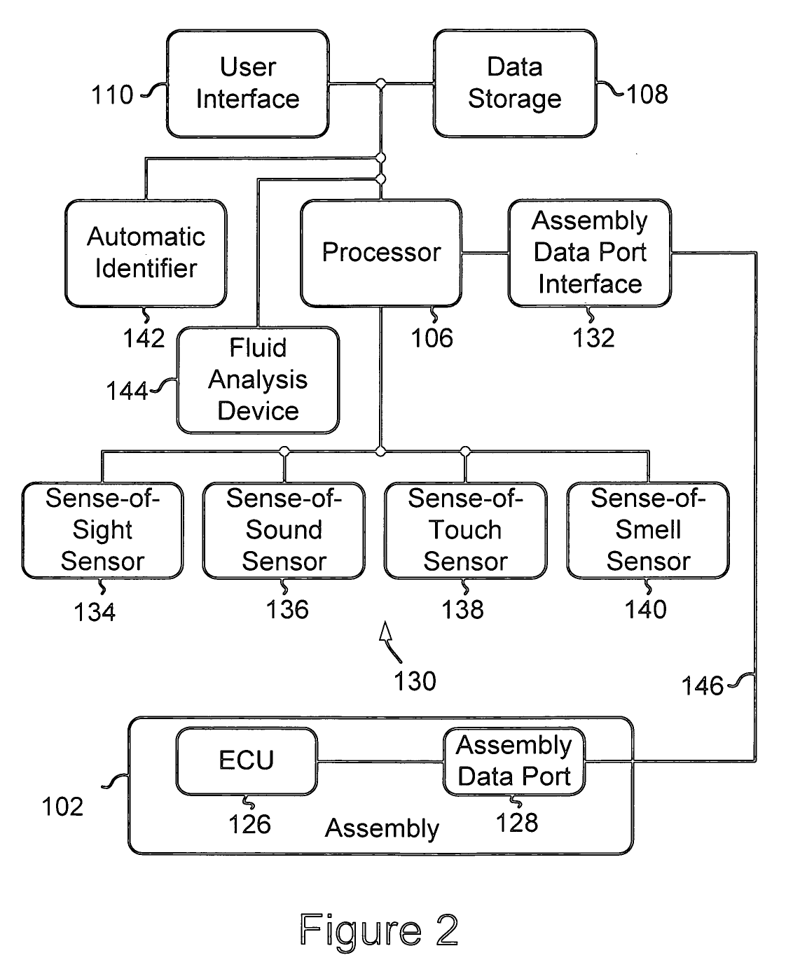

Turning next to FIG. 2, the assembly 102 is shown with additional details. In this regard, the assembly 102 includes an electronic control unit (ECU) 126. An ECU can control various components of the assembly 102. As an example, the ECU 126 is a automobile powertrain controller that electronically controls an automobile's engine and transmission. The assembly 102 could include more than one ECU.

The ECU 126 produces assembly data. Assembly data is data associated with the assembly such as data indicating assembly operating conditions. Assembly data may be arranged in various formats. For example, the assembly data could be arranged according to the Society of Automotive Engineers (SAE) J1850 specification entitled Class B Data Communications Network Interface. Other examples of ECU and assembly data are also possible.

The ECU 126 is coupled to an assembly data port 128. The ECU 126 can send assembly data to the assembly data port 128. Assembly data sent to the assembly data port 128 may be used for assembly manufacturing or diagnostic purposes. As an example, the assembly data port 128 is a data link connector arranged according to the SAE J1962 specification entitled Diagnostic Connector Equivalent to ISO/DIS 15031-3. Other examples of the assembly data port 128 are also possible.

In FIG. 2, a system 130 for diagnosing the assembly 102 is shown. The system 130 includes the processor 106, the data storage 108, the user interface 110, a data port interface 132, a sense-of-sight sensor 134, a sense-of-sound sensor 136, a sense-of-touch sensor 138, a sense-of-smell sensor 140, an automatic identifier 142, and a fluid analysis device 144. The sense-of-sight sensor 134, the sense-of-sound sensor 136, the sense-of-touch sensor 138, and the sense-of-smell sensor 140 are all communicatively coupled to the processor 106 so that a respective sensor output from each of the sensors 132, 134, 136, 138 can be provided to the processor 106.

The sense-of-sight sensor 134 is a sensor that senses a sensory input that can be sensed by a human being's sense of sight. In this regard, the sensory input is electromagnetic radiation in the visible light range (light waves). The visible light range for a human being includes light waves having lengths from approximately 400 nanometers to approximately 750 nanometers. In addition to sensing light waves in the visible light range, the sense-of-sight sensor 134 may sense light waves outside of the visible light range, such as ultraviolet waves, which range from approximately 10 nanometers to approximately 400 nanometers.

The light waves sensed by the sense-of-sight sensor 134 may be produced by various light sources. For example, the sense-of-sight sensor 134 may sense light waves emitted by the assembly 102. As another example, the sense-of-sight sensor may sense light waves emitted from a light source external to the assembly 102 and which reflect off the assembly 102.

The sense-of-sight sensor 134 may be an image-capturing mechanism, such as a digital camera. An image-capturing mechanism may include an image sensor, which is a semiconductor device that detects light indicative of an image and produces an electronic representation of the image to be stored as an array of pixels. The sense-of-sight sensor 134 may capture a single image (or more than one image, such as a video sequence) for storage in the data storage 108 as a digital image.

The sense-of-sight sensor 134 senses a light wave(s) and responsively produces a sense-of-sight sensor output (e.g. an array of pixels). The sense-of-sight sensor output is sent to the processor 106 and the processor 106 in turn produces a sight-sensor pattern based on the sense-of-sight sensor output. The processor 106 sends the sight-sensor pattern to the data storage 108 for storage of the sight-sensor pattern. An example of a sight-sensor pattern is a digital image arranged according to the Joint Photographers Expert Group (JPEG) standard.

The sense-of-sight sensor 134 may work cooperatively with the automatic identifier 142 in order to make an identification. An identification may include identifying the assembly 102, or identifying a component of the assembly 102, or identifying that a component of the assembly 102 is missing. The automatic identifier may make other identifications as well. An example of the automatic identifier 142 is disclosed in U.S. Pat. No. 6,014,461 by Hennessey et al., which is entitled Apparatus and Method for Automatic Knowledge-Based Object Identification. U.S. Pat. No. 6,014,461 is hereby incorporated by reference. As another example, the automatic identifier 142 may be arranged as described in the co-pending U.S. patent application entitled Method, Apparatus, and System for Implementing Vehicle Identification, which (i) is filed concurrently herewith, (ii) has attorney reference numbers SNJ-02046 and 04-508, and (iii) is hereby incorporated by reference.

In order to make an identification, the automatic identifier 142 may receive a digital image captured by the sense-of-sight sensor 134. Afterwards the automatic identifier 142 compares the digital image to historical identification data stored in data storage 108. Historical identification data includes digital images of the assembly 102 (or a second assembly substantially identical to the assembly 102) and/or components of the assembly 102 (or a second assembly substantially identical to the assembly 102). Upon making an identification, the automatic identifier 142 produces identification data that is sent to the user interface 110 so that a user may become aware of the identification. The identification data could be used for other purposes as well.

The sense-of-sound sensor 136 senses sensory inputs that can be sensed by a human being's sense of hearing. In this regard, the sensory input is a sound wave produced by the assembly. A human being may be able to hear sound waves in the range of approximately 20-20,000 hertz (hereinafter “the audible range”). In addition to sensing sound waves in the audible range, the sense-of-sound sensor 136 may sense sound waves beyond the audible range. For example, the sense-of-sound sensor 136 may sense sound waves in an ultrasonic range of approximately 20,000-60,000 hertz. As another example, the sense-of-sound sensor 136 may sense sound waves in an ultrasonic range greater than the range of 20,000-60,000 hertz.

The sense-of-sound sensor 136 may include one or more sensors. For example, the one or more sense-of-sound sensors could include a sensor, such as a microphone, for sensing sound waves in the audible range and a sensor, such as an ultrasonic transducer, for sensing sound waves in an ultrasonic range. As another example, the sense-of-sound sensor 136 may include a plurality of audible range sensors spaced apart at the assembly and/or a plurality of ultrasonic range sensors spaced apart at the assembly.

The sense-of-sound sensor 136 senses the sound wave and responsively produces a sense-of-sound sensor output that is indicative of the sound wave. The sense-of-sound sensor output is sent to the processor 106 and the processor 106 in turn produces a sound-sensor pattern based on the sense-of-sound sensor output. The processor 106 sends the sound-sensor pattern to the data storage 108 for storage of the sound sensor pattern.

The sense-of-touch sensor 138 is a sensor that senses a sensory input that can be sensed by a human being's sense of touch. In this regard, the sensory input may take the form of a force produced by the assembly or heat produced by the assembly. Examples of sensory inputs in the form of a force produced by the assembly 102 are a vibration, a fluid pressure, or a weight of the assembly 102. Examples of sensory inputs in the form heat produced by the assembly are a temperature of an assembly component or a flow of heat produced by the assembly 102. Other examples of sensory inputs that can be sensed by a human being's sense of touch are also possible.

The sense-of-touch sensor 138 senses the sensory input (of the type that can be sensed by a human being's sense of touch) and responsively produces a sense-of-touch sensor output. The sense-of-touch sensor output is sent to the processor 106 and the processor 106 in turn produces a touch-sensor pattern based on the sense-of-touch sensor output. The processor 106 sends the touch-sensor pattern to the data storage 108 for storage of the touch-sensor pattern.

Various sense-of-touch sensors may be used as the sense-of-touch sensor 138 or in combination to form the sense-of-touch sensor 138. For example, the sense-of-touch sensor 138 may include a sensor for sensing a force, such as a vibration detector. A vibration detector may be used to detect a vibration produced by the assembly 102 and for producing a vibration signal indicative of the vibration produced by the assembly. The vibration detector can send the vibration signal to the processor 106 so that the processor 106 can search the data storage 108 for historical vibration patterns stored in the data storage 108. In this regard, the processor 106 can compare the vibration signal to the historical vibration pattern to facilitate identification of the source of the vibration. An example of a sensor for sensing a force in the form of a vibration is the Kent-Moore brand Electronic Vibration Analyzer, model number J-38792 sold by the SPX corporation.

Another example of the sense-of-touch sensor 138 for sensing a force is a scale. A scale may be used to determine a weight of the assembly 102 and for producing weight data indicative of the weight of the assembly 102. The scale can send the weight data to the processor 106 so that the processor 106 can search the data storage 108 for historical weight data stored in the data storage 108. In this regard, the processor 106 can compare the weight data to the historical weight data to facilitate identification of the assembly. An example of a scale is the Truckmate®t brand truck scale, model number 7562 sold by the Mettler Toledo International, Inc. As another example, the scale could be a scale having a model number EESE 122A, EESE 123A, EESE 124A, or EESE 135A, which are manufactured by Maschinenbau Haldenwang GmbH & Co. KG of Haldenwang, Germany.

Yet another example of the sense-of-touch sensor 138 is an accelerometer. An accelerometer is a device that can measure acceleration and produce an electrical signal that indicates a measured level of acceleration. An accelerometer may be used in performing assembly diagnostics. As an example, an accelerometer may be used to determine an assembly acceleration rate and produce an acceleration signal that indicates the assembly acceleration rate. In this regard, the acceleration signal may be compared to a historical acceleration signal for determining whether an assembly is accelerating at a specified acceleration rate represented by the historical acceleration signal. Other examples of using an accelerometer are also possible.

Still yet another example of the sense-of-touch sensor 138 is a torque sensor. A torque sensor may be used in performing assembly diagnostics. As an example, a torque sensor may be used to determine whether a fastener, such as a bolt or screw, is tightened at a level that meets a torque specification. The torque specification indicates the amount of force that should be used to tighten the fastener. If the fastener is not tightened to the torque specification, the fastener may be the cause of an assembly malfunction. As an example, an assembly manufacturer may specify that a bolt that secures a ground wire to the assembly be tightened to a torque specification of 30 pound-feet (lb.-ft.). In this regard, if the bolt is not tightened to 30 lb.-ft., the assembly may malfunction. Various types of torque sensors may be used. As an example, the torque sensor may be a sensor that has the torque sensing capabilities of an electronic torque wrench, such as the Electrotork® torque wrench, model number QCE215A, sold by Snap-on® Incorporated. Other examples of a torque sensor, as well as other examples of the sense-of-touch sensor 138, are also possible.

The sense-of-smell sensor 140 is a sensor that senses sensory inputs that can be sensed by a human being's sense of smell. In this regard, the sensory input may be a gas or vapor associated with the assembly 102. For instance, the assembly 102 may include an internal combustion engine that produces combustion gases. A human being may be able to detect that the internal combustion engine is “running rich” (i.e. using a higher than normal ratio of fuel to air) or “running lean” (i.e. using a lower than normal ratio of fuel to air) by smelling the exhaust gas. Other examples of sensory inputs that can be sensed by a human being's sense of smell are also possible.

The sense-of-smell sensor 140 senses the sensory input (of the type that can be sensed by a human being's sense of smell) and responsively produces a sense-of-smell sensor output. The sense-of-smell sensor output is sent to the processor 106 and the processor 106 in turn produces a smell-sensor pattern based on the sense-of-smell sensor output. The processor 106 sends the smell-sensor pattern to the data storage 108 for storage of the smell-sensor pattern.

Various sense-of-smell type sensors may be used as the sense-of-smell sensor 140 or in combination to form the sense-of-smell sensor 140. For example, the sense-of-smell sensor 140 may include an exhaust gas analyzer. A exhaust gas analyzer may be used to detect the composition of an exhaust gas produced by an internal combustion engine of the assembly 102 and for producing a gas analysis signal indicative of the composition of the assembly gas. The exhaust gas analyzer can send the gas analysis signal to the processor 106 so that the processor 106 can search the data storage 108 for historical gas analysis patterns indicative of gas compositions produced by the assembly. In this regard, the processor 106 can compare the gas analysis signal to the historical gas analysis patterns to facilitate diagnosing the assembly 102.

An example of a sensor for sensing an exhaust gas is the Flexible Gas Analyzer model number EEEA300A sold by Snap-on® Incorporated, which can provide readings for the content of hydro-carbons (HC), carbon monoxide (CO), carbon dioxide (CO₂), oxygen (O₂), and nitric oxide (NO) in a combustion gas. Other examples of sense-of-smell type sensors are also possible.

Although FIG. 2 depicts that the system 130 includes the sense-of-sight sensor 134, the sense-of-sound sensor 136, the sense-of-touch sensor 138, and the sense-of-smell sensor 140, the system 130 may use fewer sensors than those depicted in FIG. 2. For example, the system 130 may comprise any two sensors of the sensors selected from the group consisting of the sense-of-sight sensor 134, the sense-of-sound sensor 136, the sense-of-touch sensor 138, and the sense-of-smell sensor 140. As another example, the system 130 may comprise any three sensors selected from the group consisting of the sense-of-sight sensor 134, the sense-of-sound sensor 136, the sense-of-touch sensor 138, and the sense-of-smell sensor 140. The system 130 could also comprise other sensors in addition to any combination of the sense-of-sight sensor 134, the sense-of-sound sensor 136, the sense-of-touch sensor 138, and the sense-of-smell sensor 140.

The data storage 108 may include historical patterns related to sensor outputs of the sense-of-sight sensor 134, historical patterns related to sensor outputs of the sense-of-sound sensor 136, historical patterns related to sensor outputs of the sense-of-touch sensor 138, and historical patterns related to sensor outputs of the sense-of-smell sensor 140. The data storage 108 may also store assembly diagnostic guidelines and/or assembly repair instructions based on sensor outputs sensed by the sense-of-sight sensor 134, the sense-of-sound sensor 136, the sense-of-touch sensor 138, and the sense-of-smell sensor 140.

The data port interface 132 acts as a gateway for the system 130 to communicate with the assembly 102. The data port interface 132 may be arranged according to the SAE J1962 specification or according to another specification. The system 130 may communicate with the assembly 102 to receive assembly data that relates to the assembly 102. For example, the assembly data may include data such as an operating temperature of the assembly 102, an engine speed in revolutions per minute (RPM), or an assembly speed in miles per hour (MPH). Other examples of assembly data are also possible.

In order to communicate assembly data between the assembly 102 and the system 130, the data port interface 132 is communicatively coupled to the assembly data port 128. In this regard, an assembly data cable 146 could be used to communicatively couple the assembly data port 128 and the data port interface 132. In another regard, wireless communication methods may be used to communicatively couple the assembly data port 128 and the data port interface 132.

The assembly data cable 146 allows the processor 106 to receive assembly data sent to the data port interface 132 via the assembly data port 128. After receiving the assembly data, the processor 106 can place the assembly data in data storage 108, such as in random access memory (RAM). After receiving the assembly data, the processor 106 could search the data storage 108 for historical assembly data related to the assembly data and compare the historical assembly data to the assembly data to facilitate diagnosing whether the assembly 102 is malfunctioning or operating normally.

Further, the historical assembly data could be correlated with (i) historical patterns related to sensor outputs of the sense-of-sight sensor 134, or (ii) the historical patterns related to sensor outputs of the sense-of-sound sensor 136, or (iii) the historical patterns related to sensor outputs of the sense-of-touch sensor 138, or (iv) the historical patterns related to sensor outputs of the sense-of-smell sensor 140. The correlated historical assembly data and patterns can be stored in data storage 108 as additional diagnostic information that can be used to diagnose the assembly.

Correlating the historical assembly data with historical patterns can reduce the burden of searching for an optimal historical pattern for the assembly being diagnosed. An optimal historical pattern is the best historical pattern to use for a particular assembly malfunction being diagnosed. In order to locate an optimal historical pattern, the processor 106 may receive assembly data (e.g. an engine RPM or assembly speed) and then search for historical patterns correlated with historical assembly data that is similar to the received assembly data.

For example, the processor 106 can receive assembly data that indicates the assembly engine is operating at 3,000 RPM. In this regard, the processor 106 can search the data storage 108 for historical patterns correlated with historical assembly data indicating that the historical pattern was captured when an assembly test engine was operating at 3,000 RPM. In this regard, the historical pattern correlated with historical assembly data of 3,000 RPM is, in most cases, a more optimal historical pattern than historical patterns correlated with historical assembly data of some number of RPM greater than or less than 3,000 RPM.

The assembly 102 may use various types of fluids for assorted reasons. For example, the assembly 102 may use engine oil for lubricating an assembly engine and an engine coolant, such as an ethylene glycol coolant, for cooling an assembly engine. Other examples of fluids used by the assembly 102 are also possible.

The fluid analysis device 144 may be used to analyze an assembly fluid and to produce fluid analysis data indicative of a fluid condition. An example of fluid analysis data is data indicating that the assembly fluid is contaminated. In this regard, the assembly fluid could be engine oil contaminated with a bearing material from worn engine bearings. Fluid analysis data may be used to facilitate assembly diagnosis.

The fluid analysis device may include a fluid capture device for capturing the assembly fluid to be analyzed. An example of a fluid capture device is a drain pan placed under the assembly 102 to capture assembly fluid exiting through a drain hole.

The fluid analysis device 144 is communicatively coupled to the processor 106 so that the processor 106 may receive the fluid analysis data. In this regard, the processor 106 may search the data storage 108 to locate historical fluid analysis data related to the assembly fluid being analyzed and compare the fluid analysis data to the historical fluid analysis data. Thereafter, the processor 106 may send the fluid analysis data and the historical fluid analysis data to the user interface 110 for display of the fluid analysis data and the historical fluid analysis data.

An example of the fluid analysis device 144 is the On-Site Analyzer described in U.S. Pat. No. 6,707,043 by Coates et al. U.S. Pat. No. 6,707,043 is hereby incorporated by reference. Other examples of the fluid analysis device 144 are also possible.

3. Example of Operating a System for Assembly Diagnosis

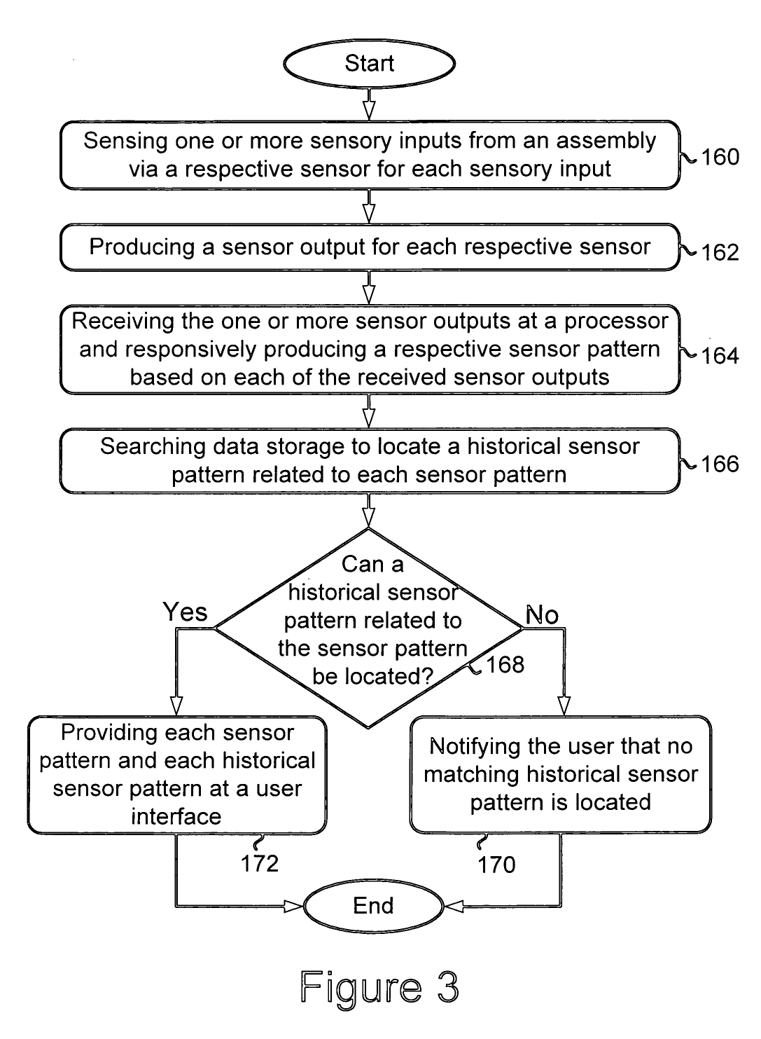

Referring to FIG. 3, a flow chart is provided to help illustrate some of the functions that can be carried out in accordance with a system for assembly diagnosis. The system 130 shown in FIG. 2 is used as an example system to describe the functions shown in FIG. 3. As shown in FIG. 3, at block 160, one or more sensors sense sensory inputs from an assembly 102. Each sensory input is a type of sensory input that can be sensed by a human sense in addition to a sensor in the system 130.

At block 162, each sensor produces a sensor output based on the respective sensory input sensed by the sensor. As an example, each sensor may sense a sensory inputs, such as an assembly vibration, or a sound wave, or a light wave, or a combustion gas produced by the assembly 102. The sensor outputs are produced in response to sensing the sensory inputs at the respective sensors.

In order to sense the sensory inputs, it may be necessary to position the one or more sensors at various locations in close proximity to the assembly 102 or at a location(s) on the assembly 102 itself. In one regard, various mechanisms may be used to keep the sensors in position while performing the assembly diagnosis. For example, a portable cart may include sensors mounted in place on the portable cart. The portable cart may be positioned as needed to place the sensors in proper position for performing assembly diagnosis. As another example, a mechanism, such as an alligator clip, may be used to keep a sensor in position. Other examples of mechanisms for keeping a sensor in position during assembly diagnosis are also possible. In another regard, a sensor may be a hand-held sensor that a user can position by hand and hold in place during assembly diagnosis.

At block 164, the processor 106 receives the one or more sensor outputs from the sensors and responsively produces a respective sensor pattern based on each received sensor output. Producing a sensor pattern may involve converting an analog sensor output to a digital sensor output. Producing a sensor pattern may involve storing digital values of the sensor output received over a given length of time. Producing the sensor pattern may occur as the sensor output is stored in data storage 108. Other examples of steps involved in producing a pattern are also possible.

Various types of sensor patterns may be produced. For example, a sensor pattern may take the form of an image, such as an image of a waveform that can be displayed on an oscilloscope or an image of an assembly component that can be displayed on an LCD display. As another example, a sensor pattern may take the form of a sound recording, such as the sound of an engine noise caused by a worn or damaged engine bearing. Other examples of sensor patterns are also possible.

At block 166, the processor 106 performs a search for historical sensor patterns stored in data storage 108. Performing the search may involve searching through data storage that includes historical patterns for more than one type of assembly. For example, the assembly 102 may be a vehicle manufactured by the General Motors Corporation and the data storage 108 may store historical sensor patterns for all vehicle models produced by the General Motors Corporation. In this regard, the processor 106 searches through data storage that includes historical patterns for more than just the assembly 102.

To facilitate searching the data storage 108, a user of the system may identify the assembly 102 and then enter assembly identification data into the system 130 via the user interface 110 so that the system 130 can more easily locate historical patterns based on the assembly 102 being diagnosed. Alternatively, the data storage 108 may store historical patterns that allow the system 130 to identify the assembly 102 being diagnosed. For example, the system 130 may capture an image of the assembly 102 and/or weight data associated with the assembly 102 and then compare historical patterns in the form of assembly images and/or assembly weight data in order to identify the assembly 102.

Further, searching the data storage 108 may include the processor 106 executing pattern recognition software in the form of machine language instructions for comparing a sensor pattern to one or more historical patterns. For example, the comparison may involve comparing feature vectors of the patterns. In this regard, the pattern recognition software could take the form of a computer program described in U.S. Patent Application Publication US 2004/0039572 A1 by Kiss et al. and entitled Pattern Recognition. U.S. Patent Application Publication US 2004/0039572 A1 is hereby incorporated by reference.

Next at block 168, a determination is made whether a respective historical sensor pattern (or more than one historical sensor patterns) related to the sensor pattern(s) is located in the data storage. For example, if there are two sensor patterns produced, separate determinations are made for each of the two sensor patterns. In this regard, the same historical pattern could be located for each of the two sensor patterns, and/or one or more different historical sensor patterns could be located for each of the two sensor patterns. The determination at block 168 may be made separately for each sensor pattern, such that an affirmative determination could be made for one or more sensor patterns and a negative determination could be made for one or more other sensor patterns.

If the determination (for a given sensor pattern) at block 168 is negative (no), then at block 170, the user is provided with notification that no matching historical sensor pattern was located for at least one sensor pattern. The notification could occur via various means, such as displaying a message on a display and/or providing an audible message to the user.

If the determination (for a given sensor pattern) at block 168 is affirmative (yes), then at block 172, the sensor patterns produced by the processor 106 and the historical patterns located by the processor 106 may be provided at the user interface 110. Various methods may be used to provide the sensor patterns and the historical sensor patterns at the user interface 110. For example, the user interface 110 may include one or more displays for showing the sensor patterns and historical sensor patterns. In this regard, for example, the user interface 110 may (i) display only one patter at any given time, or (ii) display in combination a sensor pattern that is related to a historical sensor pattern, or (iii) display multiple sensor patterns and historical sensor patterns simultaneously. Other examples of how the user interface 110 provides the sensor and historical patterns are also possible.

The user interface 110 may also allow one pattern, such as a sensor pattern, to be overlaid on top of a second pattern, such as a historical sensor pattern. Overlaying patterns permits patterns to be placed closer together so that a better comparison of the two or more patterns can be made to diagnose the assembly 102.

The user interface 110 may also provide diagnostic information, such as assembly diagnostic instructions and/or assembly repair instructions. The diagnostic and/or assembly repair instructions may be provided in combination with a historical pattern(s) and/or a sensor pattern(s).

### 4. CONCLUSION

An example of a system and method for assembly diagnosis has been described above. Those skilled in the art will understand, however, that changes and modifications may be made to these examples without departing from the true scope and spirit of the system and method for assembly diagnosis, which are defined by the claims.

1-6. (canceled)

7. A system for diagnosing an assembly, the system comprising:
a vibration sensor for sensing an assembly vibration and for producing a vibration signal indicative of the assembly vibration;
data storage that includes a plurality of historical vibration patterns;
a processor communicatively coupled to the vibration sensor and to the data storage, wherein the processor (i) receives the vibration signal and (ii) searches the data storage to find at least one of the historical vibration patterns which is related to the assembly and the vibration signal; and
a user interface to display the vibration signal and the at least one of the historical vibration patterns.

8. The system of claim 7, further comprising:
a data port interface for receiving assembly data from the assembly,
wherein the data port interface is communicatively coupled to the processor,
wherein the data storage further includes (i) historical assembly data, and (ii) diagnostic information based on the vibration signal and the assembly data,
wherein the processor (i) receives the assembly data, and (ii) searches the data storage to find the diagnostic information, and
wherein the processor provides the diagnostic information to the user interface.

9. The system of claim 8, wherein the historical vibration signals are correlated with the historical assembly data.

10. (canceled)

11. The system of claim 8, wherein the historical assembly data includes assembly data that indicates a known good operating condition of the assembly.

12. The system of claim 8, wherein the diagnostic information includes assembly repair instructions.

13. The system of claim 8, wherein the diagnostic information includes assembly diagnostic instructions.

14-15. (canceled)

16. The system of claim 7, wherein the historical vibration patterns include vibration patterns that indicate a known malfunctioning operating condition of the assembly.

17. (canceled)

18. The system of claim 7, further comprising:
an image-capturing mechanism for capturing a digital image; and
an automatic identifier for making an identification and producing identification data,
wherein the data storage further includes historical identification data and the automatic identifier makes the identification by comparing the digital image to the historical identification data, and
wherein the identification data is sent to the user interface.

19-20. (canceled)

21. The system of claim 18, wherein making the identification includes making an identification from the group consisting of: (i) identifying a component of the assembly, and (ii) identifying that the component is missing from the assembly.

22. The system of claim 7, further comprising:
a sound-wave sensor for sensing a sound-wave produced by the assembly and for producing a sound signal indicative of the sound wave,
wherein the sound-wave sensor is communicatively coupled to the processor,
wherein the data storage includes historical sound patterns,
wherein the processor (i) receives the sound signal, and (ii) searches the data storage to find at least one of the historical sound patterns which is related to the sound signal, and
wherein the user interface displays the sound signal and the at least one of the historical sound patterns.

23. The system of claim 22, wherein the sound wave is audible to a human being.

24. The system of claim 22, wherein the sound wave is ultrasonic.

25-26. (canceled)

27. The system of claim 7, further comprising:
a gas analysis device for analyzing a gas associated with the assembly and for producing gas analysis signal indicative of a gas composition,
wherein the gas analysis device is communicatively coupled to the processor,
wherein the data storage includes historical gas analysis patterns,
wherein the processor (i) receives the gas analysis signal, and (ii) searches the data storage to find at least one of the historical gas analysis patterns, and
wherein the user interface displays the gas analysis signal and the at least one of the historical gas analysis patterns.

28. The system of claim 27, wherein the gas associated with the assembly is a combustion gas produced by the assembly, and wherein the gas analysis device is an exhaust gas analyzer for analyzing the gas composition.

29. A system for diagnosing an assembly, the system comprising:
a first sensor for producing a first sensor output in response to sensing a first type of sensory input, wherein at least a portion of the first type of sensory input can be sensed by a human being's sense of touch;
a second sensor for producing a second sensor output in response to sensing a second type of sensory input, wherein at least a portion of the second type of sensory input can be sensed by a human being's sense of sight;
data storage, wherein the data storage includes historical patterns of the first and second types of sensory input;
a processor for (i) receiving the first sensor output and thereafter sending the first sensor output to data storage for storage as a first sensor pattern, (ii) receiving the second sensor output and thereafter sending the second sensor output to the data storage for storage as a second sensor pattern; (iii) searching the data storage to locate first and second historical patterns, wherein the first historical pattern is a historical pattern of the first type of sensory input that is related to the first sensor pattern and the second historical pattern is a historical pattern of the second type of sensory input that is related to the second sensor pattern; and
a user interface to display the first sensor pattern, the first historical pattern, the second sensor pattern, and the second historical pattern.

30. The system of claim 29, wherein the user interface displays (i) the first sensor pattern and the first historical pattern simultaneously, and (ii) the second sensor pattern and the second historical pattern simultaneously.

31. The system of claim 29, wherein the first sensor is an electronic vibration analysis device and the first sensory input is an assembly vibration.

32. The system of claim 29, wherein the second sensor is an image-capturing mechanism and the second sensory input is a light wave reflecting from the assembly.

33-43. (canceled)

44. A method for diagnosing an assembly, the method comprising:
sensing a first type of sensory input from the assembly and responsively producing a first sensor pattern based on the first type of sensory input, wherein the first type of sensory input can be sensed by a first human-sense;
sensing a second type of sensory input from the assembly and responsively producing a second sensor pattern based on the second type of sensory input, wherein the second type of sensory input can be sensed by a second human-sense;
searching a data storage device that includes (i) a plurality of historical patterns of the first type of sensory input, and (ii) a plurality of historical patterns of the second type of sensory input, to locate (i) at least one of the plurality of historical patterns of the first type of sensory input that is related to the first sensor pattern, and (ii) at least one of the plurality of historical patterns of the second type of sensory input related to the second sensor pattern that is related to the second sensor pattern; and
providing, at a user interface, the first and second sensor patterns, the at least one of the plurality of historical patterns of the first type of sensory input, and the at least one of the plurality of historical patterns of the second type of sensory input.

45. The method of claim 44, wherein the providing function involves (i) simultaneously displaying the first sensor pattern and the at least one of the plurality of historical patterns of the first type of sensory input, and (ii) simultaneously displaying the second sensor pattern and the at least one of the plurality of historical patterns of the second type of sensory input.

46. (canceled)
